(19) United States
(12) Patent Application Publication
(10) Pub. No.: US 2003/0071850 A1
(43) Pub. Date: Apr. 17, 2003

(54) In-place adaptive handwriting input method and system

(75) Inventor: Erik M. Geidl, Bellevue, WA (US)

Correspondence Address: LAW OFFICES OF ALBERT S. MICHALIK, PLLC, Suite 193, 704-228th Avenue NE, Sammamish, WA, 98074, US

(73) Assignee: Microsoft Corporation

(21) Appl. No.: 09/976,188

(22) Filed: Oct. 12, 2001

(51) Int. Cl. G09G 5/00

(52) U.S. Cl. 345/781; 345/863

(57) ABSTRACT

A system and method that displays a semi-transparent user input interface relative to an application's currently focused input field at times when handwritten input is appropriate. The semi-transparent user interface starts when a program's text input field receives focus, can grow as needed to receive input, or will disappear when not used for a time. Handwritten data is recognized and passed to the application as if it was typed in the focused field, and the application need not be aware of handwriting, as the system and method are external to the application. Pen events that are not handwriting, but comprise gestures directed to the program through the semi-transparent input user interface, are detected by a gesture detection engine and sent to the application. A user is thus guided to enter handwriting, while handwriting recognition appears to be built into applications, whether or not those applications are aware of handwriting.

### FIELD OF THE INVENTION

The present invention relates generally to computing devices, and more particularly to handwritten input used with computing devices.

### BACKGROUND OF THE INVENTION

Contemporary computing devices allow users to enter handwritten words (e.g., in cursive handwriting and/or printed characters), characters and symbols (e.g., characters in Far East languages). The words, characters and symbols can be used as is, such as to function as readable notes and so forth, or can be converted to text for more conventional computer uses. To convert to text, for example, as a user writes strokes representing words or other symbols onto a touch-sensitive computer screen or the like, a handwriting recognizer (e.g., trained with millions of samples, employing a dictionary, context and/or other rules) is able to convert the handwriting data into dictionary words or symbols. In this way, users are able to enter textual data without necessarily needing a keyboard.

Applications have been developed that know how to handle such handwritten input, including sending the user input to a recognizer at appropriate times. These applications provide the user with various features related to both the handwritten ink as written and the text as recognized. Such applications generally provide specific areas for entering handwritten character input via pen activity directed to those areas. Other application areas such as menu bars, command buttons and the like are also provided, however since they are controlled by the application, the application treats pen activity differently in those areas, e.g., pen commands are treated as mouse clicks, not as handwritten symbols that correspond to user data input.

However, many applications are only written for text recognition and do not handle handwritten data entry. With such applications, any handwritten data input and recognition needs to be external to the application, and performed in a manner such that only recognized text is fed to the application. Some computing devices provide an input area for this purpose, with recognized text placed in a character queue or the like which is read in by the application as if the input was typed on a physical or virtual keyboard. One problem with such a scheme is that there is a spatial disconnection between the writing area and displayed text area, which can be confusing, especially for applications having multiple text input fields. Another problem is that part of the screen needs to be reserved for this input area, which reduces the display area available to the application program.

An improved mechanism for providing handwritten input as text to applications is described in U.S. Pat. Nos. 5,946,406, 5,956,423 and 6,269,187, assigned to the assignee of the present invention. This mechanism provides a data entry program that overlaps a window of a computer application program with an invisible window, whereby the data entry program can receive handwritten data, have it recognized, and send the recognized data to the computer application program as if the data had been entered from the keyboard. Because the data entry program's invisible window overlaps the window of the computer program, it appears to the user as if the computer program is directly accepting handwritten data, thus overcoming the spatial disconnect problem.

While such a mechanism provides numerous benefits, such a transparent, full window mechanism still leaves many users without direction as to where and when writing is appropriate. Further, the ability to write anywhere can confuse users at times. For example, handwritten input near the bottom of the invisible window may appear as text at the top of a word processing document, or may appear in a different field than the one the user wants the text to be entered into. In general, improvements to the general concept of receiving handwritten input and converting it to text for processing by other programs would benefit many users.

### SUMMARY OF THE INVENTION

Briefly, the present invention provides a system and method that provides a visible, preferably semi-transparent (e.g., lightly-tinted) user input interface that is displayed in a location relative to an application's currently focused input field, at times when handwritten input is appropriate, such that users intuitively understand when to enter handwritten input and where in the application that text recognized from the handwritten input will be sent. The semi-transparent user interface adapts to current conditions, such as by growing as needed to receive input, or fading from view when not in use. Further, the semi-transparent user interface provides support for pen events that are not handwriting, but rather are gestures directed to the application program or input system. Such gestures received at the semi-transparent input user interface are detected and sent to the application or handled at the input system. The application program need not be aware that handwriting is occurring, as the system and method are external to the application. Thus, existing, text-based applications (i.e., having “legacy” input fields) can benefit from the present invention. Application programs that are aware of the semi-transparent user interface of the present invention may communicate with it, such as to control its appearance, relative position, size and so forth.

To provide the semi-transparent input user interface, a field typing engine determines the attributes of the application's field that has current input focus. The field typing engine is invoked whenever input focus changes, and automatically determines whether the field is of a known, supported type. If so, this type (and related information) is passed to the semi-transparent input user interface, which then displays itself in the proper position and size. Thus, the input system/method adaptively places the semi-transparent user interface at or near the application field that has input focus, and adaptively grows and flows the user interface into new regions based on handwriting input. The blended aspect of this user interface allows the end-user to see the input field, and other user interface elements (e.g., a close button and a submit button) framing the input field.

The semi-transparent user interface appears when the input focus changes, and will disappear or fade from view if the user does not provide input thereto within a certain period of time to make the system and method less intrusive to the user. To this end, when the semi-transparent input user interface is displayed, a timing mechanism is invoked to wait for input from the user. If no user interaction with the semi-transparent input user interface is observed for a certain period of time, the timing mechanism dismisses the semi-transparent input user interface. Any interaction with the semi-transparent input user interface sets the timing mechanism to a new state, one of which might be an infinite timeout. For example, the timing mechanism may be set to an infinite timeout state when the user has entered ink at the semi-transparent input user interface.

As the user interacts with the semi-transparent input user interface, the input is provided to a gesture engine, to determine if the input is actually a gesture rather than handwritten data. If the gesture engine determines that the ink is a gesture, then any ink is removed from the semi-transparent input user interface and the gesture behavior is invoked.

As the user adds ink to the semi-transparent input user interface, a user interface growth rulebase evaluates whether to adjust the appearance of the semi-transparent input user interface, e.g., the extent to grow or shrink it and alter its layout. This provides the user with an adaptive extended writing area without incurring the initial imposition of a large user interface.

Once the user has completed inking, the ink is provided to the handwriting recognition engine, either as a result of an event from the timing mechanism, or as the result of an explicit user action (e.g., a “Submit” button press) on the semi-transparent input user interface. The recognition result is provided to the application program window that had focus when sent to the recognition engine. In this manner, the user is guided to enter handwriting, while handwriting recognition appears to be built into application programs, whether or not those applications are aware of handwriting.

Other advantages will become apparent from the following detailed description when taken in conjunction with the drawings, in which:

### BRIEF DESCRIPTION OF THE DRAWINGS

FIG. 1 is a block diagram representing an exemplary computer system into which the present invention may be incorporated;

FIG. 2 is a block diagram generally representing components for providing the in-place adaptive handwriting system and method in accordance with an aspect of the present invention;

FIG. 3 is a representation of a display showing an application program having various input fields into which handwritten data may be entered in accordance with an aspect of the present invention;

FIGS. 4A-4C are representations of the display over time including a semi-transparent input user interface positioned relative to an input field of an application program for receiving handwritten input, in accordance with an aspect of the present invention;

FIGS. 5A-5B are representations of the display over time including a semi-transparent input user interface alternatively positioned relative to an input field of an application program and growing in size to receive handwritten input, in accordance with an aspect of the present invention;

FIGS. 6A-6B are representations of the display over time including a semi-transparent input user interface positioned relative to an input field of an application program for receiving handwritten input or gestures, in accordance with an aspect of the present invention;

FIG. 7A is a block diagram generally representing the interaction between components for providing the in-place adaptive handwriting system and method in accordance with an aspect of the present invention;

FIG. 7B is a block diagram generally representing an application that is aware of the in-place adaptive handwriting system and method and interacting therewith in accordance with an aspect of the present invention; and

FIGS. 8-10 comprise a flow diagram generally representing various steps that may be executed to provide the in-place adaptive handwriting system and method, in accordance with an aspect of the present invention.

### DETAILED DESCRIPTION

Exemplary Operating Environment

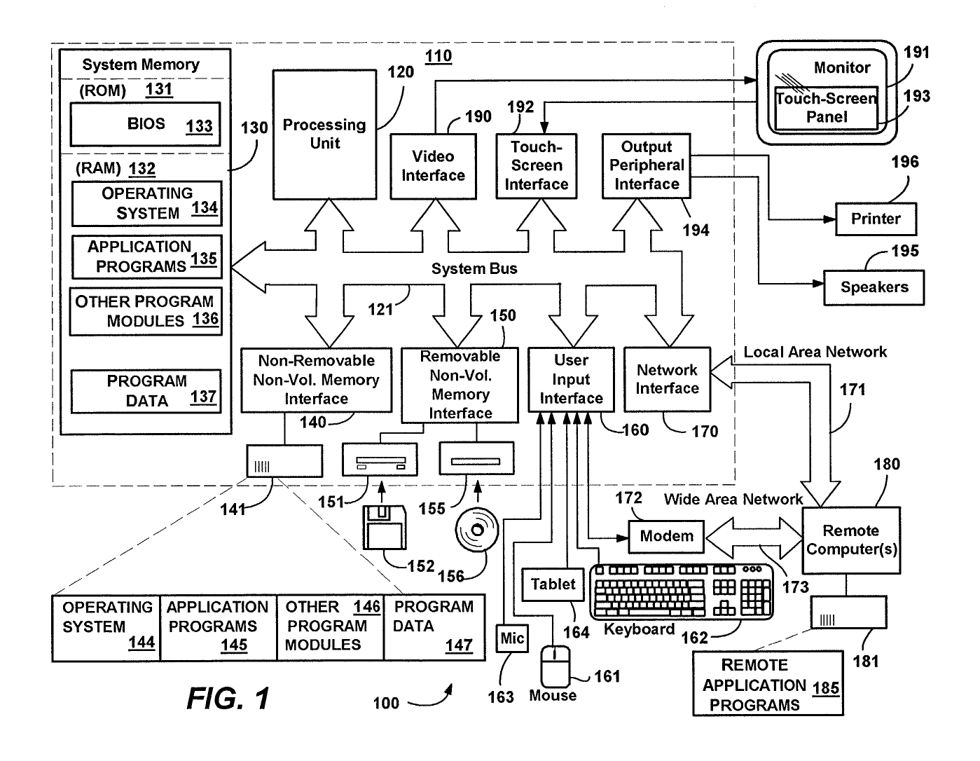

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a tablet (electronic digitizer) 164, a microphone 163, a keyboard 162 and pointing device 161, commonly referred to as mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel 193 or the like that can input digitized input such as handwriting into the computer system 110 via an interface, such as a touch-screen interface 192. Note that the monitor and/or touch screen panel can be physically coupled to a housing in which the computing device 110 is incorporated, such as in a tablet-type personal computer, wherein the touch screen panel 193 essentially serves as the tablet 164. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

In-Place Adaptive Handwriting Input

The present invention is primarily directed to electronic ink, which in general corresponds to a set of X, Y coordinates input by a user, and some additional state information. Notwithstanding, it will be appreciated that the present invention is applicable to virtually any type of user input that corresponds to words or symbols that can be mixed with and/or recognized as text, such as speech data. Thus, although for purposes of simplicity the present invention will be described with reference to handwriting input and display thereof, and will use examples of English cursive handwriting, the present invention should not be limited in any way to handwritten input and/or by the examples used herein.

As a further simplification, the user may be considered as entering ink input via a pen-tip (cursor) that writes on a tablet-like device, such as the touch-screen panel 193. Note that this may not be literally correct for all devices and/or in all instances. For example, some devices such as a mouse or a pen capture device do not have a real, physical tablet and/or pen-tip. For such devices, a virtual tablet may be assumed. In other instances, electronic ink may be generated by an application program or other software, in which event the tablet and pen-tip may both be considered to be virtual.

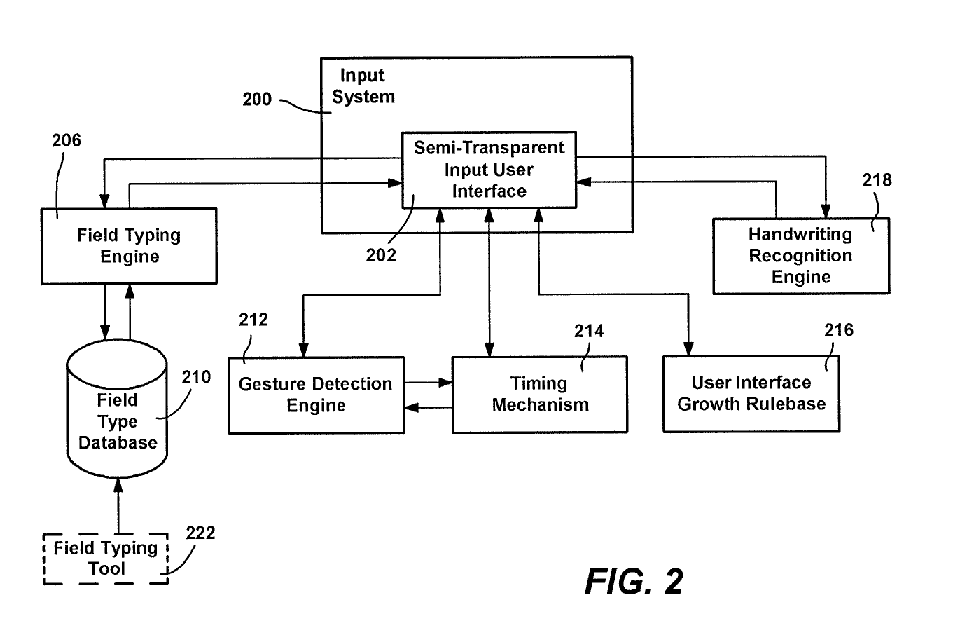

As generally represented in FIG. 2, an input system 200 is provided to receive user input data, such as in the form of electronic ink input via a pen contacting the touch-screen panel 193. The input system 200 is generally an operating system component or the like, but may instead be an application program. The input system 200 may provide various functions and tools, including those directed to speech, handwriting recognition, drawing and so forth.

In accordance with one aspect of the present invention, the input system includes or is otherwise associated with a visible, preferably semi-transparent input user interface 202, a field typing engine 206, a gesture detection engine 212, a timing mechanism 214 and a user interface growth rulebase 216. A handwriting recognition engine 218 is also available to convert handwritten data to one or more computer values (e.g., ASCII or Unicode) representing recognized symbols, characters, words and so forth. Note that the present invention is independent of any particular recognition technique. Further, note that while these components are shown as logically separate entities, it is understood that some or all of the structure and/or functionality provided thereby may be combined into a lesser number of components, or further separated into even more components.

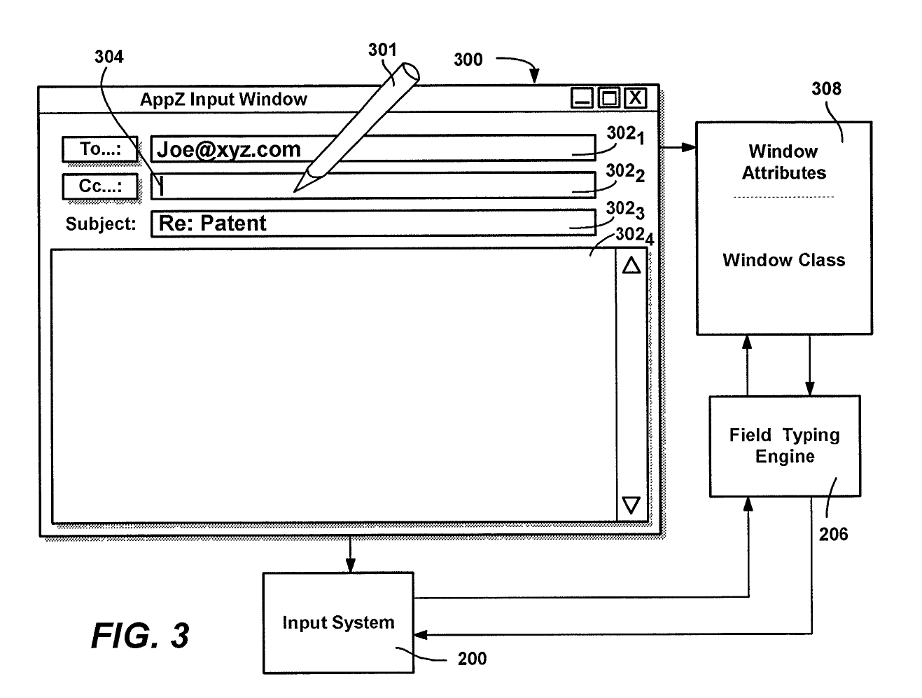

The field typing engine 202 is invoked whenever input focus changes, and determines whether the field is of a known type. For example, FIG. 3 shows focus being changed by the user contacting a field 302₂ (e.g., a window) of an application program 300. Note that the field does not need to be an HWND (window or the like), although most fields in applications running in the Windows® operating system do have their own HWND. When focus is present, the application typically provides a blinking cursor 304 or the like to indicate to the user that the field 302₂ is ready for text. Note that it is feasible to have the field typing engine invoked in some other manner, such as predictively when user activity is detected near a field, rather than on an actual focus change. Alternatively, the field typing engine can scan the various program fields to evaluate their attributes before each is focused, and thereby collect some of the field information in advance of receiving focus. As is understood, such detection before a field receives actual focus is basically equivalent to waiting for focus.

In keeping with the invention, the input system 200 (or another suitable operating system component) invokes the field typing engine 206, which evaluates the window attributes 308 of the currently focused field. Note that these attributes are maintained by the operating system 134, and, for example, can be obtained via an application programming interface (API) call to the operating system. The field typing engine 206 may thus operate external to the application program, whereby existing programs need not be modified to benefit from the present invention. Moreover, while the present invention is described with reference to an application program, it will work with other alternative types of software that have at least one input area, including objects, operating system components, and so forth, and it is understood that the terms “program,” “application, “application program” or the like encompass and/or are equivalent to these alternatives.

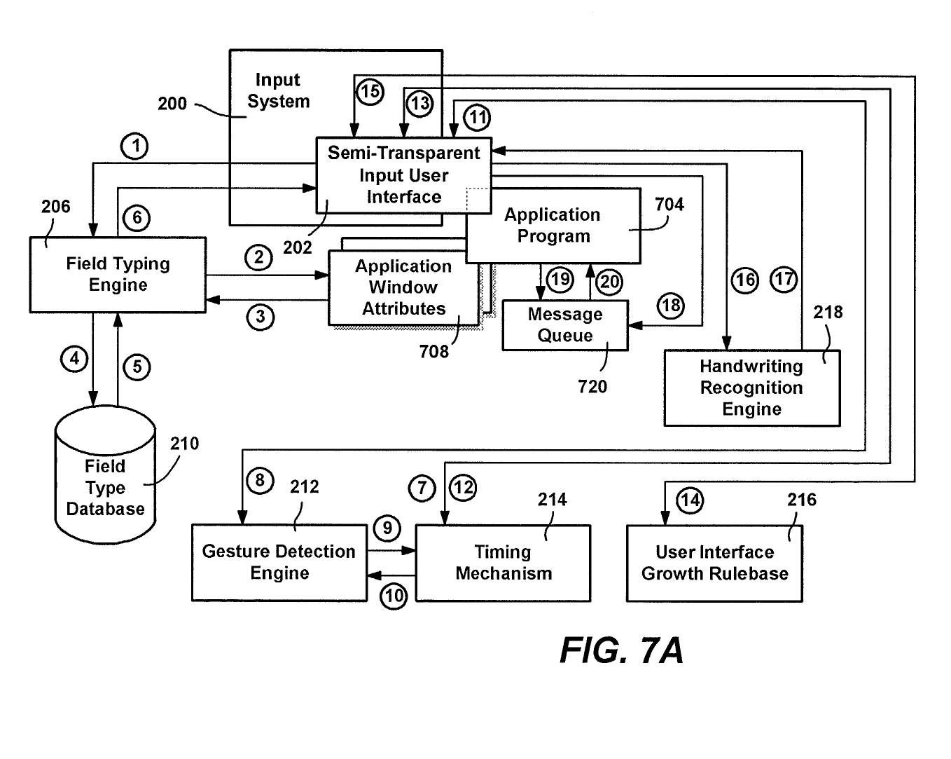

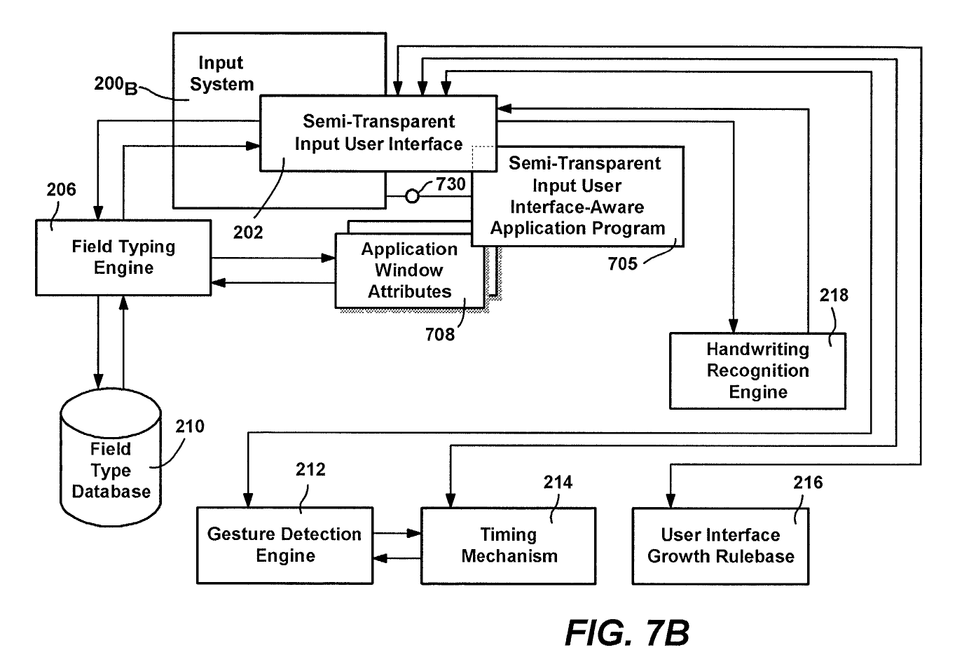

If the type of input field is one that is supported, the field typing engine 206 will pass the type information to the semi-transparent input user interface 202, which displays itself in a proper position and size. Note that information such as the coordinates of the focused field 302₂ may be passed to the semi-transparent input user interface 202, or the semi-transparent input user interface 202 can obtain this information from the operating system, to render itself at a suitable position. Indeed, it is alternatively feasible that the field typing engine has some or all of its functionality built into the semi-transparent input user interface 202, e.g., instead of making the decision, the field typing engine can simply retrieve and forward the window attributes or a pointer thereto to the semi-transparent input user interface 202, which then determines whether the field type is supported. Moreover, application programs that are aware of the semi-transparent user interface of the present invention may communicate with it, such as to control its appearance, relative position, size and so forth. To this end, the semi-transparent input user interface 202 may comprise an object that exposes methods via an interface or the like, or may comprise another type of software code that otherwise provides callable functions, as generally discussed below with reference to FIG. 7B.

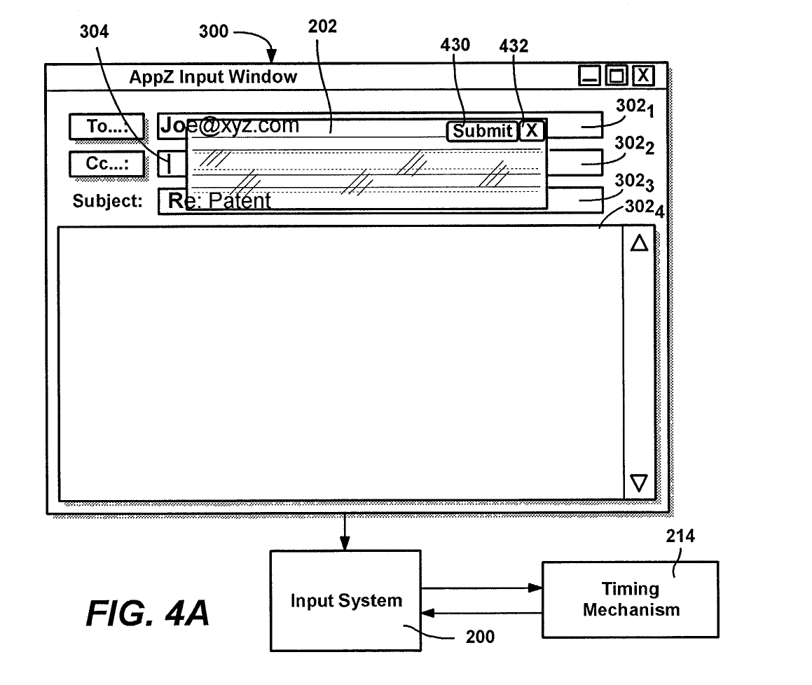

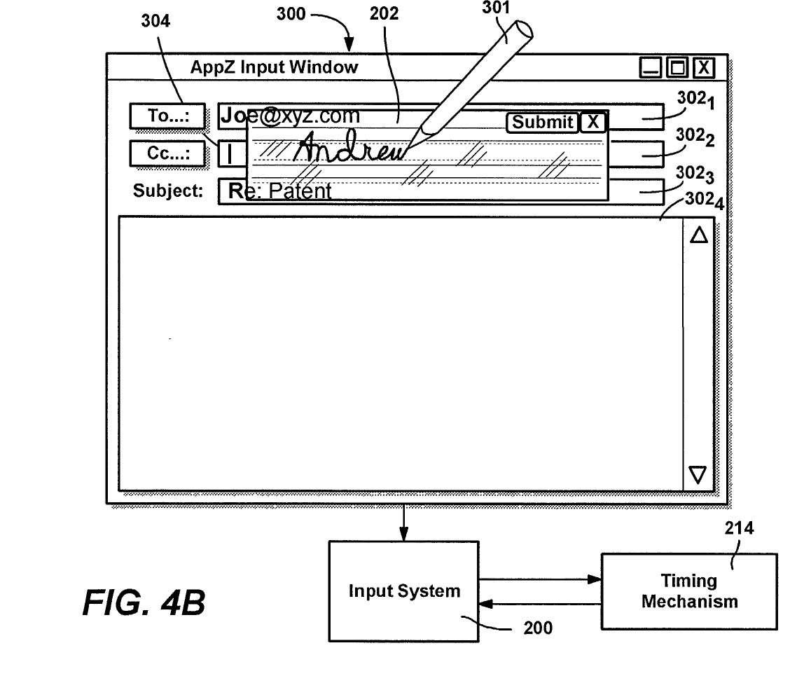

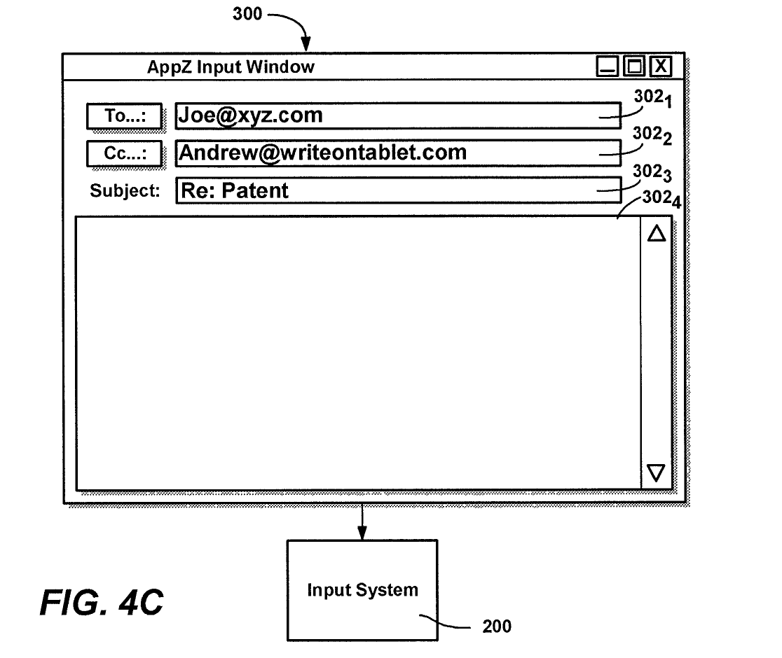

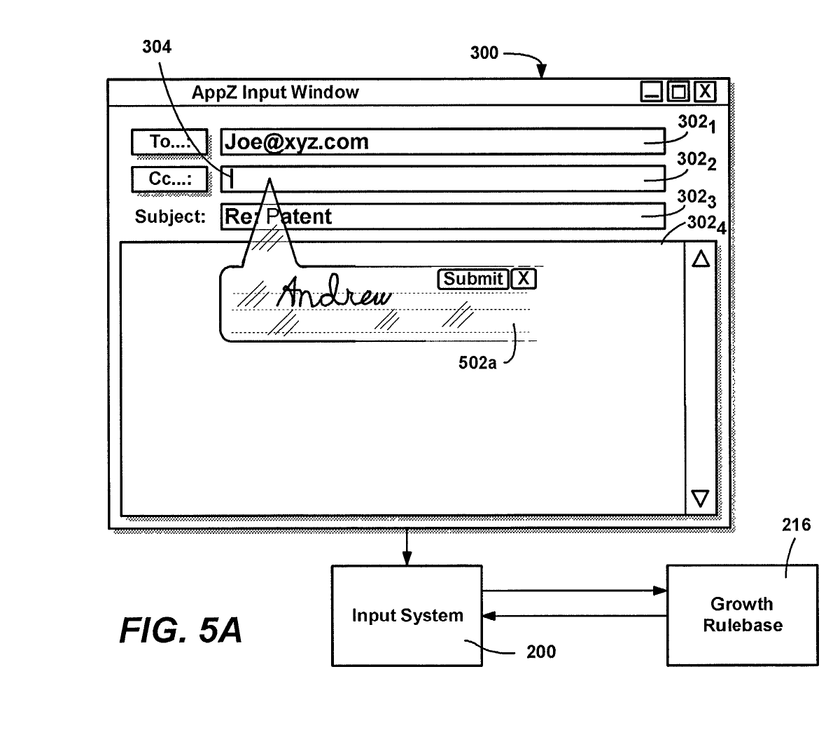

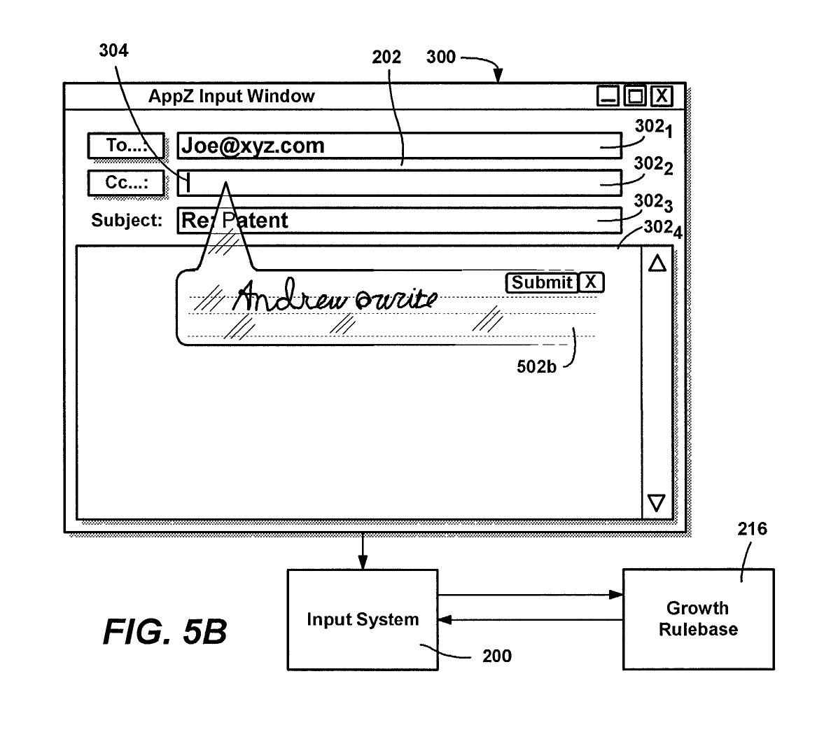

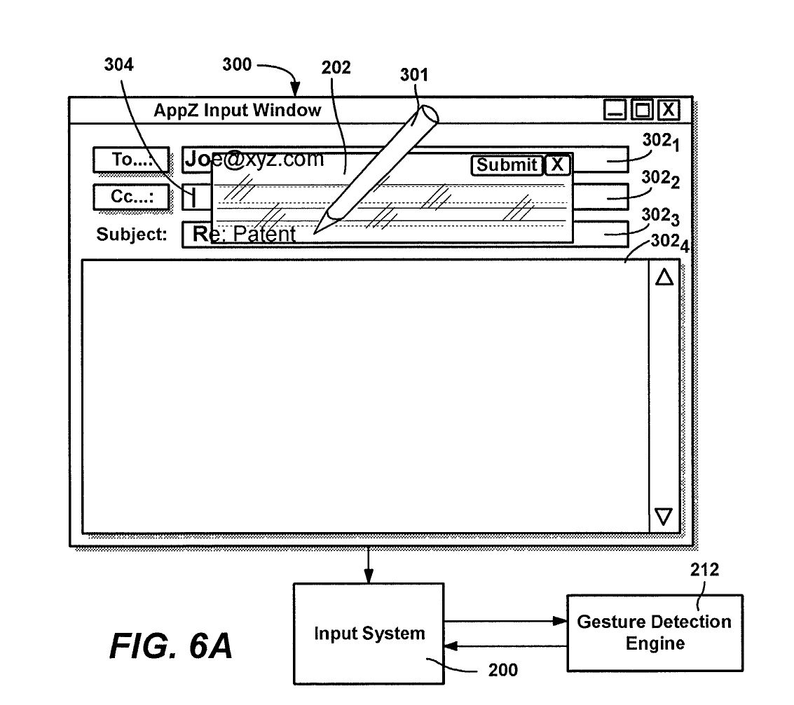

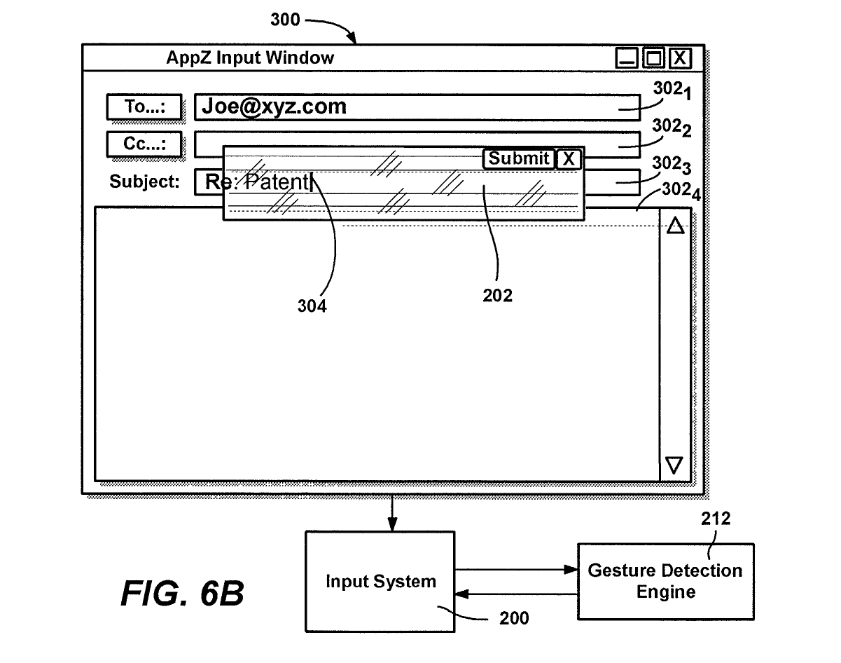

By way of an example of the display of the semi-transparent user interface 202, FIG. 4A shows the semi-transparent user interface 202 positioning itself over the “Cc” field 302₂ provided by an application program 300 for entering the name of an e-mail message recipient. By “semi-transparent,” it is meant that the user can see through the displayed user interface 202, but the interface is visible in some way, typically by being tinted with some color that is different than the background color behind it. The semi-transparent input user interface 202 may be framed or outlined, such as with a solid line, and may include writing guidelines (e.g., the dashed lines in the interface FIGS. 4A-6B) to assist the user with the writing input. Different levels of transparency are possible, such as to display an input area that gradually fades out (becomes more and more transparent) toward its right side, so as to indicate to the user that the input area can grow, as generally represented and described below with reference to FIGS. 5A and 5B. As is understood, the gradual fading represented in the semi-transparent input user interfaces 502ₐ and 502_{b} of FIGS. 5A and 5B can also apply to the semi-transparent input user interface 202 represented in FIGS. 4A, 4B, 6A and 6B. Note that support for such transparency already exists in contemporary computing devices, and, for example, transparency functions can be accessed via API calls or the like.

One supported type of input field corresponds to the window attribute's class data being a “RichEdit32” field or the like. Many fields into which text can be entered have this as their window class, and thus this class may be hard-coded into the filed typing engine 206. Other supported field types may be stored in a field typing database 210 or the like. The vendor that provides the input system 200, or a third party, or even the user, can maintain entries in the field typing database 210 for this purpose. For example, an optional field typing tool 222 may be provided that instructs the user to click (tap the pen 301) on an unsupported field, and then, when clicked, the field typing tool 222 adds the clicked field's window class data (and possibly other data to more particularly identify this field, such as a control identifier and the text preceding the window to develop a more unique signature, which are also available attributes) to the field typing database 210. In this manner, other field types can be supported. Note that it is also possible to exclude certain types of fields, such as those specifically known to not receive recognition results, e.g., drawing fields.

When the semi-transparent input user interface 202 is displayed, the timing mechanism 214 is invoked to wait for input from the user. If no user interaction with the semi-transparent input user interface 202 is observed for a certain period of time, then the timing mechanism 214 dismisses the semi-transparent input user interface 202, such as by issuing an event or by calling the semi-transparent input user interface 202. Note that in an alternative model, the semi-transparent input user interface 202 can poll the timing mechanism 214 instead of an event or callback model, or in another model, the semi-transparent input user interface 202 can include its own timing mechanism. Via the timing mechanism 214, the semi-transparent input user interface 202 can also adjust its appearance over time, e.g., fade more and more if unused until it is dismissed completely, or if previously used to enter input, to adjust its appearance to indicate that an automatic recognition (timed-out, as described below) is forthcoming.

If user interaction with the semi-transparent input user interface 202 takes place, the timing mechanism 214 may be reset or set to a new state, one of which might be an infinite timeout. For example, the preferred embodiment sets the timing mechanism 214 to an infinite timeout state when the user has placed ink on the semi-transparent input user interface 202, so that any user-entered ink is not accidentally lost. To this end, the timing mechanism 214 can be instructed to not fire the “not used” timing event, or the semi-transparent input user interface 202 can simply ignore any such event. For example, in FIG. 4B, the user has begun writing in the displayed semi-transparent input user interface 202, and thus the timing mechanism 214 is in the infinite timeout state.

A Submit button 430 and close button 432 are provided with the semi-transparent input user interface 202, whereby the user can manually cause ink to be submitted to the recognition engine 218 and/or close the semi-transparent input user interface 202, respectively. Note that the Submit button 430 may be hidden or grayed-out until some ink is received. Also, the close button 432 may cause any existing ink to be automatically sent to the recognition engine 218, or may cause a prompt to the user to be displayed via which the user can either discard the ink or have it recognized.

In accordance with another aspect of the present invention, as the user interacts with the semi-transparent input user interface 202, the ink is passed through a gesture detection engine 212, to determine if the ink is actually a gesture, that is, a pen event directed to the input system or some area below the semi-transparent input user interface 202, and not handwriting data. If the gesture detection engine 212 determines that the ink is a gesture, then the ink (e.g., resulting from a pen tap) is removed from the semi-transparent input user interface 202, and the gesture behavior is invoked. In a preferred embodiment, one such gesture includes a “click-through to the underlying application” gesture, which is detected by determining that the user has caused pen down and pen up events in a small region, possibly within a certain short period of time. Such activity is sent to the application as a left mouse button down and up event. Another gesture is referred to as a “hold-through to the underlying application” gesture, which is detected by determining that the user has caused a pen down event and thereafter has deliberately paused in approximately the same position. Such activity results in subsequent pen behavior being converted into mouse actions. The gesture detection engine 212 can work with the timing mechanism 214 if needed, or can analyze the events (which typically comprise coordinates and timestamp information) to determine timing matters. Other types of gestures include those directed to the input system 200, such as a “recognize the ink now” gesture, or a “clear/erase the written ink” gesture.

By way of example of gesture detection, FIGS. 6A and 6B represent click through detection by the gesture detection engine 212, and the subsequent result. In FIG. 6A, the user has done an activity that has caused focus to be on the “Cc:” field input, (e.g., tapped that field 302₂). As described above, this causes the gesture detection engine 212 to be invoked, which draws itself over the “Cc:” field 302₂. However, the user wants focus to be on the “Subject:” field 302₃ input area, and thus taps the pen 301 on that window area through the semi-transparent user interface 202, as generally shown in FIG. 6A. The input system 200 receives the input, (e.g., in a queue of the semi-transparent input user interface 202), passes it to the gesture detection engine 212 (or otherwise instructs the gesture detection engine 212 to look at queue of events), and the gesture detection engine 212 determines that it is a click-through gesture. The semi-transparent user interface 202 erases itself, and pen down and pen up events are provided to the application. For example, applications that can only handle limited types of input can have the events placed in (e.g., copied to) the application's message queue as if the semi-transparent input user interface 202 was not present. In keeping with the invention, because this causes focus to change to the “Subject:” field 302₃, the semi-transparent input user interface 202 receives a field type from the field typing engine 206 and again renders itself at an appropriate location, this time relative to the “Subject:” field 302₃, as generally represented in FIG. 6B. As is understood, the gesture behavior represented in the semi-transparent input user interface 202 of FIGS. 6A and 6B also apply to the alternative semi-transparent input user interfaces 502ₐ and 502_{b} of FIGS. 5A and 5B, e.g., a gesture detected therein would be passed to the main message body window 302₄.

Note that it is likely that a gesture will occur before any writing is entered, and thus it is feasible to look for gestures only at the start of user interaction with the gesture detection engine 212. This is one way to distinguish a period “.” from a click-through. However, gesture detection can be ongoing, whereby a gesture can occur after user has also entered handwritten data. In such an event, to determine whether the user entered a period or has entered a gesture, the gesture detection engine 212 will need to evaluate the proximity of other ink, in space and/or time, to judge the user's intent. Note that if a click-through gesture is determined, any ink can be treated as if the user closed the semi-transparent input user interface 202 just prior to receiving the gesture, e.g., prompt for or automatically send the ink to the recognition engine 218, erase the displayed semi-transparent input user interface 202, receive the recognition result, provide the recognition result to the application, and then provide the click-through pen-down and pen-up events to the application. Note that this will cause a recognition delay before the application receives the click-through events, but will not lose the input, (which may be a significant amount of writing), and will keep the gesture events in their proper order relative to the recognized symbols.

In accordance with another aspect of the present invention, as the user adds ink to the semi-transparent input user interface 202, the user interface growth rulebase 216 evaluates whether to alter the semi-transparent input user interface 202, which may include determining the extent to grow or shrink it, and/or determining whether to otherwise alter its layout. In one preferred implementation embodiment, the user interface growth rulebase 216 extends the right side of the semi-transparent input user interface 202 when the ink comes within one inch of the rightmost edge of the semi-transparent input user interface 202, (although a percentage, such as grow up to twenty percent when ink exceeds eighty percent, may be more appropriate than a fixed measurement, since displays have varying sizes).

By way of example, FIGS. 5A and 5B represent the user interface growth rulebase 216 growing the semi-transparent input user interface 202 when the user approaches the right edge. Note that in FIGS. 5A and 5B, the semi-transparent input user interface 202 gradually fades out (becomes more and more transparent, as indicated in FIGS. 5A and 5B by the lessening frame thickness) toward its right side, so as to indicate to the user that the input area can grow.

The user interface growth rulebase 216 stops extending the rightmost edge of the semi-transparent input user interface 202 when the edge of the physical display (or some other suitable limit) is reached. Similarly, the semi-transparent input user interface 202 can grow downwards. For example, the user interface growth rulebase 216 may extend the bottom edge of the semi-transparent input user interface 202 when the ink comes within one inch of the bottom of the semi-transparent input user interface 202, (although again, a percentage may be more appropriate), until a downward limit is achieved. Scrolling the ink is also possible. As is understood, the user interface growth rulebase 216 thus provides the user with an adaptive, extended writing area without incurring the initial imposition of a large user interface 202. Preferably, the user can also manually adjust the size of the semi-transparent input user interface 202, e.g., by a click-and-drag operation, like resizing other windows. As is understood, the growth represented in the semi-transparent input user interfaces 502ₐ and 502_{b} of FIGS. 5A and 5B can also apply to the semi-transparent input user interface 202 represented in FIGS. 4A, 4B, 6A and 6B.

Once the user has completed inking, the ink is committed to the handwriting recognition engine 218 either as a result of an event from the timing mechanism 214, or as the result of an explicit user action, e.g., in one implementation by pressing the Submit button 430 or close button 432 on the semi-transparent input user interface 202. Another way in which ink may be automatically sent to be recognized is if the input buffer that holds the ink data is full. When received, the recognition result is made available, e.g., placed in a message queue for the application or the field that had focus when the recognition commenced. Field focus can change, so the semi-transparent input user interface 202 keeps track of which field it was used with. FIG. 4C represents the results having been provided to the application program and processed thereby.

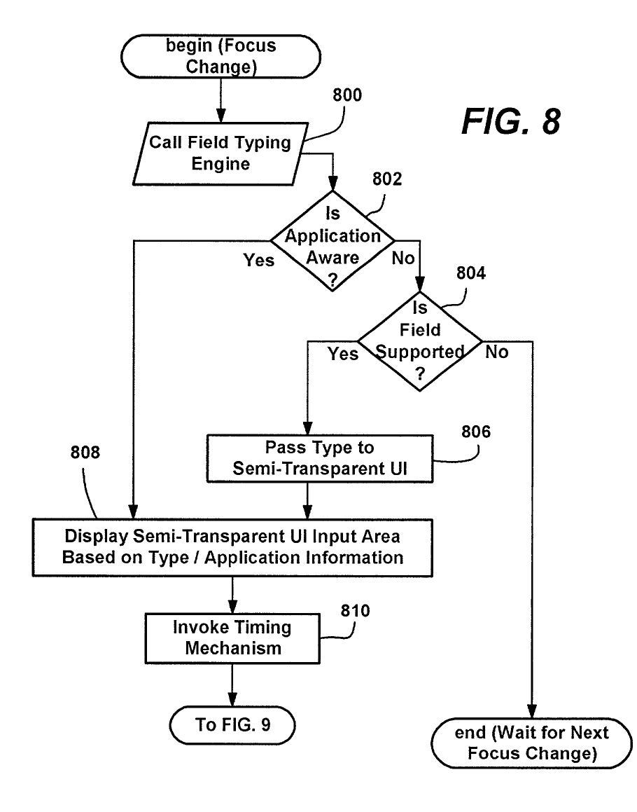

Turning to an explanation of the operation of the present invention with particular reference to FIGS. 7A-10, the general process begins on a focus change, wherein the input system 200 calls the field typing engine 206 at step 800 of FIG. 8 to determine if the focused field of the application program 704 is one that is supported for use (or otherwise will work) with the semi-transparent user interface 202. Note that it is possible that an application program has been developed with the capability of controlling (at least in part) the semi-transparent user interface 202, and has already directly or indirectly provided its information to the field typing engine 206.

By way of example, FIG. 7B provides a representation of an application program 705 that is capable of controlling (e.g., is “aware” of) the semi-transparent input user interface 202. In one such embodiment, an input system 202_{B} comprises an object or the like that provides a defined interface 730 that the aware program 705 can use to communicate information (e.g., at application start-up) to and from the input system 200_{B}, such as to control the semi-transparent input user interface's appearance, relative position, size, behavior and so forth, e.g., within allowed parameters. For example, the interface 730 can be accessed by fields which declaratively form an interface connection (e.g., essentially two way) with the input system 200, whereby the field can control the size, position, timeouts, features, and general behavior of this input system 200. Since the field, as part of the application, has the complete context of the application around it, the field can set the input system's settings in a way that is more ideal to the application. Note that alternatively, (or in addition to), the application can communicate with other components, e.g., the field typing engine 206, to directly exchange information therewith. When the application is aware in this manner, step 802 branches to step 808 to display the semi-transparent user interface based on the application's specified information for the focused field. Although not specifically shown, an aware application can provide its relevant field information in advance, e.g., at application start-up, or when a field receives focus, and/or the application or focused field can be queried for such data as needed.

In the event that the application is not aware of the semi-transparent input user interface 202, the field typing engine 206 determines whether a given focused field is supported. This is represented in FIG. 7A by the arrows labeled one (1) through six (6), and in FIG. 8 by steps 800, 804 and 806. Note that the steps described in FIGS. 8-10 are only logical steps to describe certain operations and functionality of the present invention, and that there are many ways to accomplish those operations and functionality, e.g., much of the process steps may be triggered by events rather than by continually looping. Similarly, note that the arrows in FIG. 7A are numerically labeled in a typical order, and should not be considered as the only order in which the various components operate.

After evaluating the window attributes 708 of the currently focused field, (the arrows labeled two (2) and three (3)) the field typing engine 206 may recognize the field as supported, either by being hardcoded therein, or by finding for it in the field typing database 210 (the arrows labeled four (4) and five (5)). If the focused field is not supported, the process ends and waits for the next focus change.

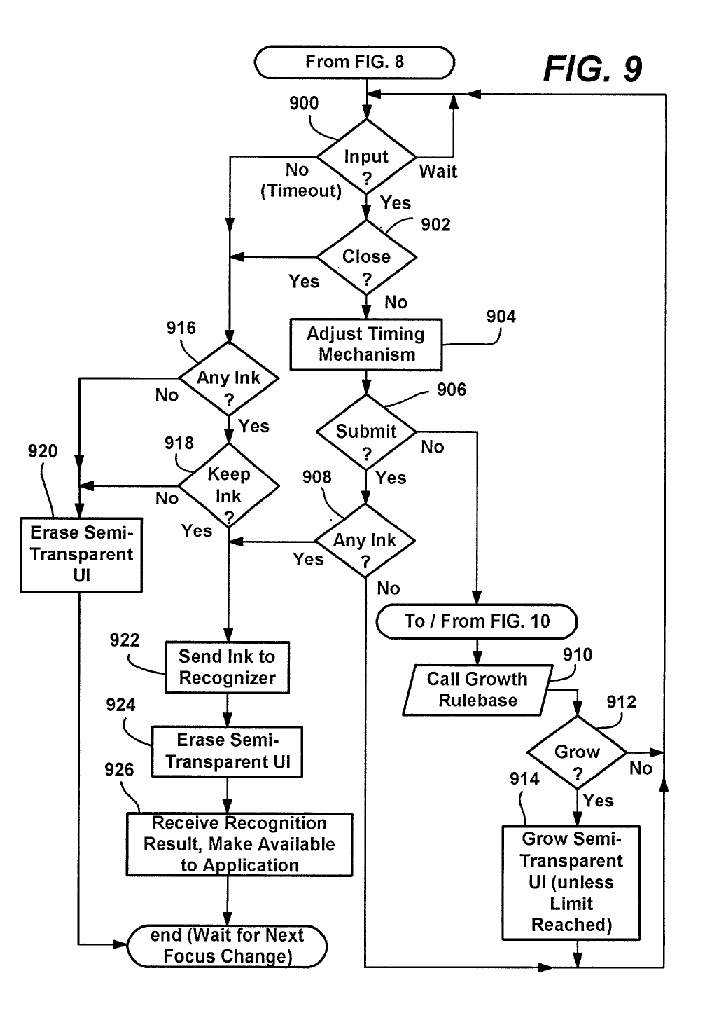

If supported at step 804, the type is passed the semi-transparent input user interface 202, as represented by step 806 in FIG. 8 and the arrow labeled six (6) in FIG. 7A. At step 808, based on this type information and other information including the field position, (or information given to the system via an application that is aware of the semi-transparent input user interface 202), the semi-transparent input user interface 202 draws itself at an appropriate location (step 808). The semi-transparent input user interface 202 then invokes the timing mechanism 214 at step 810, (as described above and as represented in FIG. 7A via the arrow labeled seven (7)), and continues to step 900 of FIG. 9.

Step 900 of FIG. 9 waits for user input, until a timeout is reached (whereby the process branches to step 916), or until user interaction is detected (whereby the process branches to step 902). Note that FIG. 9 represents the process as looping, although as understood the process is generally event driven, e.g., the timing mechanism sends a timeout event or a pen event is detected. If a timeout occurs because the user never interacted with the semi-transparent input user interface 202, then there is no ink and step 916 branches to step 920 to erase the semi-transparent input user interface 202, that is, it has been dismissed by the timeout event.

If the user interaction corresponds to the Close button 432 being pressed, as detected by step 902, then there may be ink to recognize. If no ink has been entered, step 902 branches to step 920 to erase the semi-transparent input user interface 202 and end the process (close the semi-transparent input user interface 202). If instead ink is present when the close button 432 was pressed, steps 902 and 916 branch to step 918, which represents determining whether the ink should be kept. Note that this may always the case (in which event step 918 is unnecessary and step 916 branches directly to step 922), or the user can set whether to keep ink on close. Alternatively, a prompt may be given to a user who selects the close button when ink is present to determine what to do with it. If the ink is not to be kept at step 918, the process branches to step 920 to erase the semi-transparent input user interface 202 and end the process. If the ink is to be kept, step 918 branches to step 922 to send the ink to the recognition engine 218 and erase the semi-transparent input user interface 202 (step 924). Step 926 represents receiving the recognition result and sending the result to the application program 704. The input system 200 attempts to provide the input to the extent the application can receive it, e.g., applications which support the input system 200 receive rich context and the like behind the text strings, such as text alternates (e.g., the first through best estimates from the recognizer) and so forth. Note that an application may support the input system 200 and receive the enhanced data without being aware of the semi-transparent user interface 202. Applications that do not support the input system 200 can receive the recognition result in other ways, e.g., by copying it into the application program's message queue 720 for the appropriate field. This is generally represented in FIG. 7A via the arrows labeled sixteen (16) through eighteen (18), with arrows nineteen (19) and twenty (20) representing the application program 704 processing the recognized results from the message queue 720.

If at step 902 it was not the close button 432 that was pressed, step 902 branches to step 904 which adjusts the timing mechanism, which is also represented in FIG. 7A via the arrows labeled twelve (12) and thirteen (13). For example, it can set the timing mechanism to an infinite timeout, and can also reset a timer that tracks whether ink should be automatically submitted to the recognition engine 218. Note that automatic submission is handled by a timeout at step 900 when there is ink at step 916, and that ink will be kept at step 918.

Step 906 represents testing whether the user has pressed the Submit button 430. If so, and ink exists at step 908, then as described above, the ink is recognized (step 922), the semi-transparent input user interface 202 erased (step 924), the results made available (step 926), and the process ends. If not, then there is nothing to recognize. Note that FIG. 9 allows the Submit button 430 to be pressed even when no ink exists, however this may not be the case, as it may be not displayed (or displayed in a grayed out manner) until ink is entered, in which case it may be ignored. In the present example, via step 908, if no ink is present when the Submit button 430 is pressed, then the process waits for further input. Note however that the timer may be reset via step 904 because it appears that the user is interested in entering input. Alternatively, a “submit with no ink” operation may be ignored, or treated like a “close with no ink” operation, described above with reference to steps 902, 916 and 920.

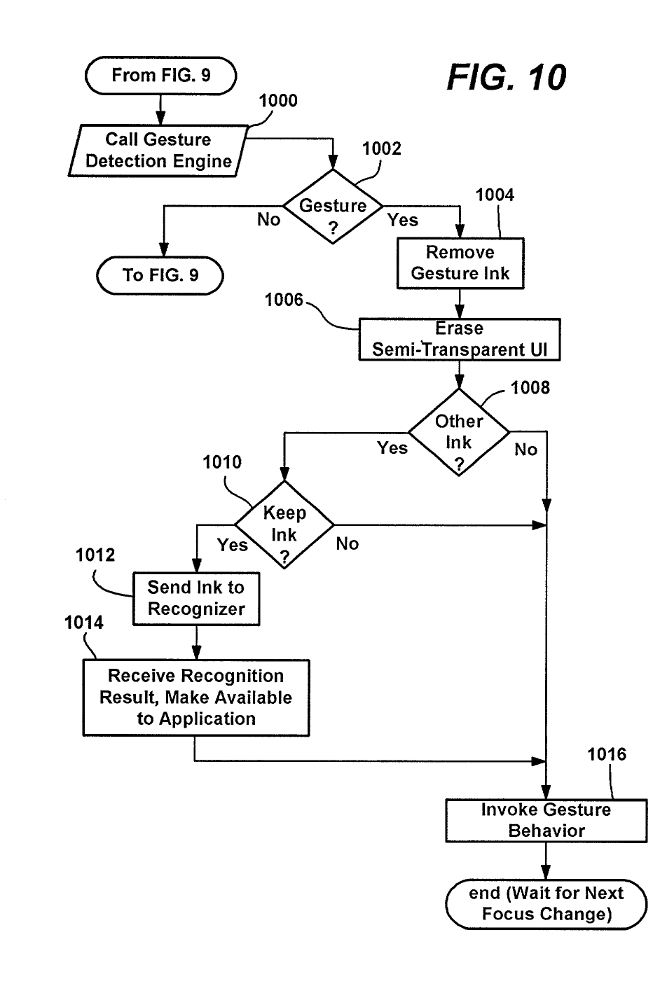

If the user interaction is on the writing input area, then the process branches to step 1000 of FIG. 10 to determine if it is handwriting data or a gesture. FIG. 10 generally represents the passing the interaction (ink) data to the gesture detection engine 212 via step 1000, which determines whether the user intended a gesture or whether the user is entering handwriting. If necessary, the process may delay rather than immediately call the gesture detection engine 212 at the first pen event, so that there will be sufficient input data for the gesture detection engine 212 to analyze. In any event, the gesture detection engine 212 engine makes a determination as to whether a gesture was intended, as represented in FIG. 10 by step 1002 and in FIG. 7A by the arrows labeled eight (8) through eleven (11). Note that FIG. 7A shows the gesture detection engine 212 communicating with the timing mechanism (the arrows labeled nine (9) and ten (10)), which may or may not be necessary. If no gesture is detected, via step 1002 the process returns to FIG. 9 to await more ink or other input.

If a gesture is detected, step 1004 removes the gesture ink from that buffered for recognition, and step 1006 erases the semi-transparent input user interface 202, which does not lose the ink data. If other ink remains, step 1008 branches to step 1010 where a determination is made as to whether the ink should be kept. Like step 918, (described above), this may always be the case, whereby step 1010 may not be present.

If there is no ink or it is not to be kept, step 1016 is directly executed, which invokes the gesture behavior as described above with reference to FIGS. 6A and 6B, e.g., the events are passed to the application. Otherwise, step 1012 is first executed to cause recognition of the ink, whereby step 1014 receives and places the recognition result in the message queue 720 or the like corresponding to the focused field of the application program 704. Then the gesture behavior is invoked at step 1016. It is possible to invoke the gesture behavior before the recognition result is received, however the events will not be synchronized with the recognized characters, which may cause problems.

As described above, the example of FIG. 10 treats a gesture like a close operation, followed by the gesture behavior being invoked. As is understood, however, a gesture alternatively can be passed as events to the application program, with no other actions taken, unless the gesture results in a focus change. For example, a gesture could clear a dialog box that popped up beneath the semi-transparent input user interface 202, without ultimately changing input focus. Such a situation can be detected so that the user can continue entering ink without having the ink presently displayed in the semi-transparent input user interface 202 sent to the recognition engine 218 e.g., until actively submitted by the user or a timeout occurs.

Returning to FIG. 9, when ink is entered that is not a gesture, step 910 is executed to call the growth rulebase, also represented in FIG. 7A via the arrows labeled fourteen (14) and fifteen (15). Note that the growth rulebase 216 may not be called every time a set of pen events are entered, but for efficiency instead may be called only occasionally, i.e., frequently enough so that a user cannot write beyond the end of the semi-transparent input user interface 202 before it grows. In any event, step 912 represents the decision whether to grow the semi-transparent input user interface 202. Step 914 represents growing the semi-transparent input user interface 202, up to the screen (or other) limits, as described above with reference to FIGS. 5A and 5B. Additional alterations to the appearance of the semi-transparent input user interface 202 may occur at this time, but are not represented in FIG. 9 for purposes of simplicity.

As can be seen from the foregoing detailed description, there is provided an input method and system including a user interface that is visible, adaptively grows and positions itself so as to be intuitive to users as to where and when handwriting input is appropriate. The input method and system further provide a semi-transparent interface that allows gestures to be input through it. Existing application programs need not be modified to benefit from the present invention, and appear to simply work with handwriting recognition. New applications can take explicit control of the input system, such as to place the semi-transparent interface more optimally, and so forth.

While the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention.

What is claimed is:

1. In a computing device having an executing program, a method comprising:
evaluating a program field that has focus against information indicative of whether the field is configured to receive text input; and
if the field is configured to receive text input:
1) providing a visible user input interface at a displayed location relative to the field;
2) receiving handwritten data at the input interface;
3) providing the handwritten data to a recognition engine; and
4) returning a recognition result to the program.

2. The method of claim 1 wherein the visible user input interface is semi-transparent.

3. The method of claim 1 wherein the handwritten data received at the input interface is evaluated to determine whether the handwritten data corresponds to a gesture.

4. The method of claim 3 wherein the handwritten data corresponds to a gesture, and further comprising, providing at least one pen event corresponding to the gesture to the program.

5. The method of claim 4 wherein the visible user input interface is semi-transparent, and wherein the gesture comprises user input directed to an area of the program that is visible through the semi-transparent user interface.

6. The method of claim 1 wherein providing the handwritten data to a recognition engine is performed in response to detection of a submit button associated with the visible user interface.

7. The method of claim 1 wherein providing the handwritten data to a recognition engine is performed in response to a time being achieved.

8. The method of claim 1 wherein providing the handwritten data to a recognition engine is performed in response to a gesture being detected.

9. The method of claim 1 wherein evaluating the program field that has focus comprises evaluating at least one window attribute corresponding to the field.

10. The method of claim 9 wherein evaluating at least one window attribute corresponding to the field comprises accessing window class information.

11. The method of claim 1 further comprising, accessing a database to obtain the information indicative of whether the field is configured to receive text input.

12. The method of claim 1 further comprising, adjusting the appearance of the visible input window.

13. The method of claim 12 wherein adjusting the appearance of the visible input window comprises increasing its size to enable entry of additional handwritten data.

14. The method of claim 1 further comprising, erasing the visible input window.

15. The method of claim 14 wherein the visible input window is erased in response to receiving a close request.

16. The method of claim 14 wherein the visible input window is erased in response to a time being achieved.

17. The method of claim 14 wherein the visible input window is erased in response to a gesture being detected.

18. In a computing device having a program, a system comprising:
user input interface code;
a field typing engine configured to evaluate a field of the program, determine if that field is supported by the user input interface code, and if so, to communicate information to the user input interface code;
the user input interface code drawing a visible input area to indicate that data may be entered therein, the drawing of the visible input area based on the information received from the field typing engine; and
a recognition engine that receives entered data from the user input interface code and converts the entered data to a recognition result that is made available to the program by the user input interface.

19. The system of claim 18, wherein the visible input area is semi-transparent.

20. The system of claim 18, wherein the field typing engine evaluates at least one window attribute corresponding to the field against hard-coded or retrieved information to determine whether the field is supported.

21. The system of claim 18 wherein the entered data comprises handwritten data, and further comprising a gesture detection engine that evaluates the handwritten data to determine whether the handwritten data corresponds to a gesture, and if so, to provide least one event to the program.

22. The system of claim 21 wherein the visible user input interface is semi-transparent, and wherein the gesture comprises user input directed to an area of the program that is visible through the semi-transparent user interface.

23. The system of claim 18 wherein the entered data comprises handwritten data, and further comprising a rulebase that determines an appearance of the visible input area including a displayed size thereof.

24. The system of claim 23 wherein the rulebase increases the displayed size of the visible input area based on handwritten data approaching an end thereof.

25. The system of claim 18 wherein the visible input area has at least one button associated therewith for receiving a command.

26. The system of claim 25 wherein at least one button comprises a submit button associated with the visible user interface, activation of the submit button commanding the user input interface code to communicate the entered data to the recognition engine.

27. The system of claim 18 wherein the user input interface code provides the recognition result to the program in a message queue associated with the program.

28. The system of claim 18 wherein the drawing of the visible input area positions the visible input area relative to the field based on the information received from the field typing engine.

29. The system of claim 18 wherein the drawing of the visible input area sizes the visible input area based on the information received from the field typing engine.

30. In a computer system having a graphical user interface, a system comprising,
an application program having at least one application input area into which user input data can be entered;
user interface code external to the application program;
a typing engine that determines whether to call the user interface code for a selected application input area of the application program based on attribute information associated with that application input area, the user interface code providing a semi-transparent input area based on the attribute information when called;
a timing mechanism configured to cause removal of the semi-transparent input area when no user interaction with the visible input area is detected for a period of time;
a gesture engine, the gesture engine invoked to determine whether user input data directed to the semi-transparent input area is a gesture directed to the application program or information that should be recognized as text; and
a handwriting recognition engine, the handwriting recognition engine configured to receive the information that the gesture engine has decided should be recognized as text, the handwriting recognition engine responding by returning recognized text when provided with the information.

31. The system of claim 30 wherein the recognized text is received by the user interface code and made available to the application program.

32. The system of claim 30 wherein the application program displays the recognized text in the application input area.

33. The system of claim 30 further comprising a growth rulebase, the growth rulebase determining whether to alter an appearance of the semi-transparent input area in response to the information received therein.
